(19) United States
(12) Patent Application Publication
(10) Pub. No.: US 2005/0130649 A1
(43) Pub. Date: Jun. 16, 2005

(54) Dynamically controlling wireless long distance routing while roaming

(76) Inventor: Richard S. Kirby, Tampa, FL (US)

Correspondence Address: RICHARD S. KIRBY, 7414 TRANSOM COURT, TAMPA, FL, 33607, US

(21) Appl. No.: 10/734,892

(22) Filed: Dec. 15, 2003

(51) Int. Cl. H04Q 7/20

(52) U.S. Cl. 455/432.1; 455/560

(57) ABSTRACT

The telecommunications network includes a mobile switching center coupled to a home location register database for accepting calls from a wireless handset, a Public Switched Telephone Network that carries calls between distant switching centers, and a local network for terminating calls. The system works while a wireless subscriber is outside their home calling area also known as “roaming”. The system includes a method for dynamically routing wireless inter-exchange (long distance) calls in a telecommunications network by sending transaction capabilities application part messages containing instructions regarding call handling. It includes a method for sending transaction capabilities application part messages containing call setup parameters between a mobile switching center and a service control platform and a method for billing the long distance calls on the wireless subscriber's monthly statement.

### BACKGROUND OF THE INVENTION

1. Field of The Invention

The present invention relates generally to telecommunications network products and, more particularly, to a method for processing wireless interchange (long distance) telephone calls while subscribers are roaming outside their local market.

2. Prior Art

Telecommunications network products are services provided by telephone companies that are carried on telecommunications networks. A widely know example is the “10-10XXX” dial around calling which allows a customer to dial 1010 plus a 3 digit carrier number and a 10 digit phone number from his or her home telephone, talk to a party who answers the telephone on the line of the ten digit number dialed. By doing this the customer chooses which long-distance company they use. Wireless carriers do not have to provide such flexibility and generally offer the wireless subscriber no choice of the long distance company they will use.

As previously mentioned, wireless calls are carried on telecommunications network. A telecommunications network comprises two basic elements; telecommunications equipment, which may also be referred to as network components, and links which connect the equipment or components. In a common channel signaling telecommunications network, two types of links connect components, signaling links and traffic links (also known as telephone lines). Signaling links carry signaling information needed to process a call between network components. Traffic links or telephone lines carry information that a customer is sending. For example, a digitalized signal of a person's voice, between network components. Components of the telecommunications network, specifically switches, establish a traffic link to carry a call by exchanging messages via signaling links. Signaling messages specify tasks to be performed on the traffic links.

When a wireless subscriber is roaming there is a plurality of messages and instructions sent on the signaling links that instruct the serving mobile switching center how to handle the subscriber's call. Calling limitations, permissions, voicemail instructions and fraud control messages are passed using an industry standard “ANSI-41” protocol.

Wireless subscribers leave their home market and take their handsets to other markets in an action called roaming. The market where a subscriber obtained their phone and resides normally is called the home market. Where a subscriber roams, the carrier providing services is called the serving carrier. There are agreements covering roaming rates but those agreements do not normally cover long distance rates.

Large carriers may route other large carrier's roamer long distance calls to a specific connection at the serving mobile switching center but it is cost prohibited to do this for smaller carriers or a carrier who has few roamers in a market. Therefore, the home carrier has no control over the routing of its subscriber's long distance calls after they leave their home market. The only way to control long distance charges is to instruct its subscribers to use a calling card with a toll free number when dialing long distance. Obviously, this requires the subscriber to control the call.

### SUMMARY OF THE INVENTION

Briefly stated, the present invention offers a wireless subscriber to be routed to the long distance network of choice regardless of the long distance company connected to the serving carrier's mobile switching center. The home carrier will decide what long distance routing is used whenever its subscriber is roaming. The service carrier will charge only for the network used from the handset to the mobile switching center normally call “airtime”.

More particularly, the present invention is directed to a mobile switching center using a signaling technique. The signaling technique involves use of a signaling message, referred to as a transaction capabilities application part message, between components to transfer information needed to process roaming wireless calls.

The telecommunications industry has developed a standard signaling method that allows telephone companies to communicate over the networks of other companies. The equipment in a telecommunications network complies with the standard so it can receive and respond to signaling messages from other equipment. The current industry standard is American National Standards Institute (ANSI) Signaling System Number 7 (SS7) Integrated Services Digital Network (ISDN) User Part (ISUP), NCT 1.113 (1995) document and the American National Standards Institute (ANSI) Signaling system Number 7 (SS7) Message Transfer Part (MTP) NCT 1.111 (1992) document which are incorporated herein by reference in their entirety. The industry standard signaling messaging used for call set-up is referred to as the initial address message.

In addition to the initial address message, the present invention uses a transaction capabilities application part message, also which also complies with the American National Standards Institute (ANSI) Signaling system Number 7 (SS7) Integrated Digital Network (ISDN) User Part (ISUP) standard, to transfer information needed to process wireless calls. The transaction capabilities application part message comprises a transaction portion and a component portion. The transaction portion indicates the type of message and elements in the network that will receive the message. The component portion includes a query or invoke message and a response message. The query or invoke message includes the operation to be performed and parameters that can be defined on a product-by-product basis. The response component indicates whether the transaction was successful, contained an error, or was rejected.

Although the format for a transaction capabilities application message complies with the industry standard signaling method, the industry standard signaling method does not specify that this message be used to signal for the routing of inter-exchange (inter-lata) wireless call processing. In addition, the signaling technique of the present invention defines parameters in the query or invoke component of the message to provide information that can be used for routing and control of wireless calls.

Although the industry signaling standard does not specify the use of a transaction capabilities message for roamer wireless call processing, because the information is translated by the equipment into a form that can be transmitted by network components, the call set-up signaling technique complies with the industry standard signaling method.

Use of the signaling technique alleviates the need for a special wireless handset or access number to direct the call to the appropriate network components. Also, services are not limited; for example, a wireless subscriber may both make and receive a call.

Further features and advantages of the invention, as well as the structure and operation of various embodiments of the invention, are described in detail below with reference to the accompanying drawings. In the drawings, like reference numbers generally indicate identical, functionally similar, and/or structurally similar elements. The drawing in which an element first appears is indicated by the leftmost digit(s) in the corresponding reference number.

### BRIEF DESCRIPTION OF THE FIGURES

The present invention will be described with reference to the accompanying drawings, wherein:

FIG. 1 is a diagram of a wireless call origination environment according to a preferred embodiment of the present invention.

FIG. 2 is a diagram showing the steps of a wireless call origination environment according to a preferred embodiment of the present invention.

FIG. 3 is a diagram showing the steps of the billing process according to a preferred embodiment of the present invention.

### DETAILED DESCRIPTION OF THE PREFERRED EMBODIMENTS

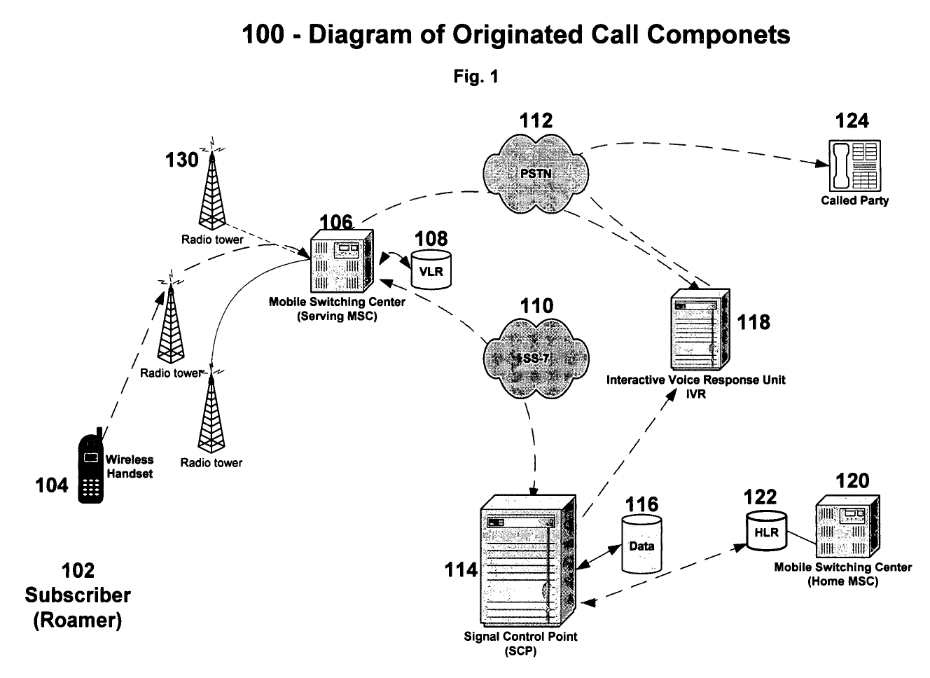

FIG. 1 is a diagram of a wireless call origination environment 100. The wireless call origination environment 100 comprises a subscriber 102, a wireless handset 104, serving mobile switching center 106, a visited location register 108, an SS7 signaling network 110, a Public Telephone Network for voice 112, an SCP (Service Control Point) 114, long distance database 116, Interactive voice response unit 118. Home mobile switching center 120, home location register (HLR) 122 and the destination phone 124, the radio towers 130.

In an originating wireless call, the caller is a wireless calling service subscriber roaming outside its home calling area 102 (also called a roamer). The roamer 102 places calls using a wireless handset 104 which is also referred to as a subscriber station, wireless telephone, or a cellular telephone. When the subscriber 102 enters calling information (i.e., dials a telephone number) via: the wireless handset 104, the wireless handset 104 signals the radio towers 130 that routes the signal to a mobile switching center 106. The mobile switching center 106 is a switch which routes calls and performs call handling functions. Multiple mobile switching centers 106 are spaced geographically apart. Each mobile switching center 106 has a corresponding database called a Visited Location Register (VLR) 108 containing subscriber information. The mobile switching center 106 accesses the database to gain information about the subscriber 102.

The home location register 122 is a functional database containing subscriber profile and mobility management information. Embodiments of the home location register 122 are described in U.S. patent application Ser. No. 08/445,997 filed Jun. 28, 1995 entitled, “Method and Apparatus for Improved Call Connectivity in an Intelligent Wireless Network,” incorporated herein by reference in its entirety.

The mobile switching center 106 obtains routing and control instructions for roamers via the SS-7 network and transaction capabilities application part messages. As discussed earlier, the format of both messages complies with the ANSI SS7 ISUP industry standard.

Calls may be routed to the Public Switched Telephone Network 112 or via dedicated lines (not shown) connected to the mobile switching center 108 or to a local Voice Over IP Internet connection in close proximity (not shown) to the mobile switching center 108. A Public Switch Telephone Network 112 comprises a plurality of switches or exchanges that are located throughout a geographic area. For example, a national Public Switched Telephone Network 112 would comprise switches located throughout the nation. When a call is routed to the Public Switched Telephone Network 112, it is routed to one or more switches within the Public Switched Telephone Network 112. The calls are routed via the Public Switched Telephone Network 112 because installing direct signaling links and telephone lines between is prohibitively expensive.

As mentioned previously, the transaction capabilities application part message is specified by the American National Standards Institute (ANSI) Signaling System Number 7 (SS7) Integrated Services Digital Network (ISDN) User Part (ISUP) standard. The three types of transaction capabilities application part messages are begin, end, and unidirectional. A begin type transaction capabilities application part message begins a transaction and needs a response. An end type transaction capabilities application part message is a response to a begin message. A unidirectional message is a message that does not require a response and is not a response.

The home location register 122 maintains two types of subscriber information: subscription information and location information. Subscription information is the services that the subscriber 102 is authorized to use. The home location register uses the subscription information to verify that the subscriber 102 is authorized for wireless service. One type of location information is the last mobile switching center 106 that was registered as serving the subscriber 102. This is stored in the form of a mobile switching center identification number that identifies the appropriate mobile switching center. Other location information is used to determine what features the subscriber has activated such as call forwarding, voicemail options and call restrictions. In addition, the subscriber is identified using a mobile identification number. Location information is used to properly route and bill the call.

The visited location register 108 contains much of the same data that the home location register 122 contains. The information on the subscriber 102 is transferred from the home location register 122 located at the home mobile switching center 120 to the visited location register 108 at the visited mobile switched center 106 when the subscriber turns on the wireless handset (subscriber registration) in a manner known by those skilled in the art.

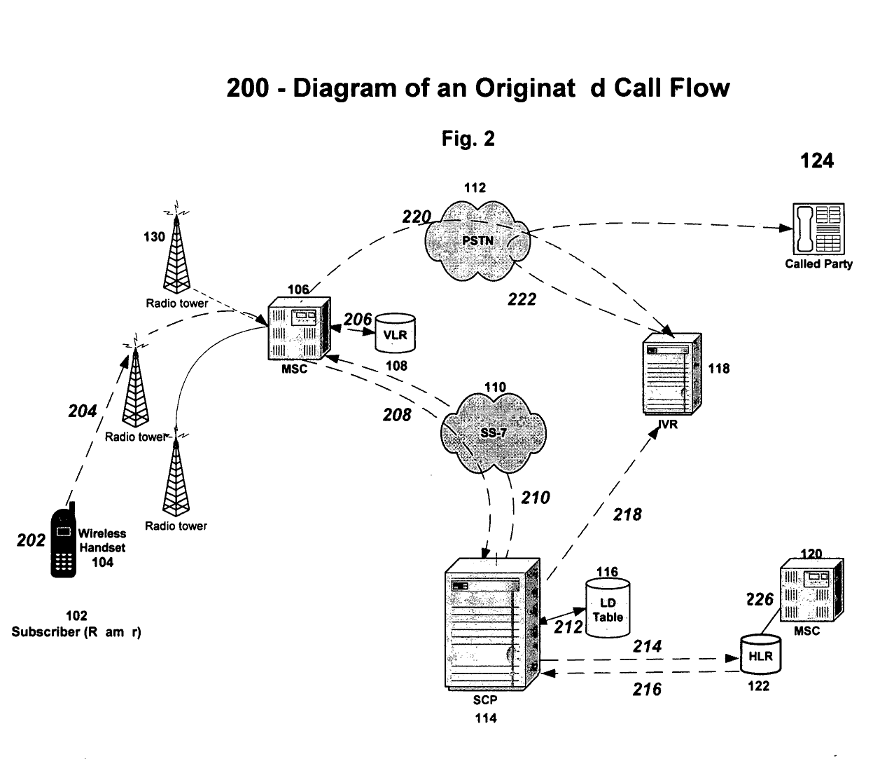

FIG. 2 represents a flowchart that illustrates the operation of the wireless call origination environment 100. When describing the steps of FIG. 2 the components shown in FIG. 1 will be referenced.

In step 204, the subscriber 102 initiates a call to a receiver 130. The subscriber 104 does this by entering digits of a telephone number in the wireless handset 202.

In previous signals (not shown) from the service control point (SCP) 114 or the home location register (HLR) 122, the mobile switching center (MSC) 106 was instructed to send a signal to the SCP 114, before the voice call is sent to the Public Switched Telephone Network 112 (PSTN) through a process known as registration. Registration occurs at various intervals and when the wireless handset 104 is turned on. The home location register may respond to the registration messages from the mobile switching center (106) and then direct the mobile switching center (106) to signal the SCP (114) instead of the HLR 122 when the subscriber (102) initiates a call. This process is well known to those skilled in the art.

In step 205, the mobile switching center 106 receives the call. The digits entered into the wireless handset 104 are transferred via a signal to the mobile switching center 106 in a well known manner.

In step 206, the mobile switching center 106 checks the VLR 108 to determine the profile of the visiting subscriber (roamer) previously received in a well know manner. The mobile switching center 106 sends an origination request to the wireless SCP 114 in step 208. This information is transferred in the component portion of the transaction capabilities application portion of the message. The parameter contents field in the query/invoke component can contain multiple parameters that are defined on a product-by-product basis. The origination request contains fields that describe the nature of the connection, the calling party, the called party, and other attributes needed to connect and bill a call. For example, the calling party number and called party number fields give routing and billing information. Also included are fields that indicate the attributes of the network the call is being carried on. For example, the nature of the connection indicators inform the receiving equipment whether satellite and echo suppression equipment are being used. A partial list of the fields of the initial address message is given in Table 1 below. The initial address message is used when a component in a telecommunications network signals to another component to set up a call.

TABLE 1 Origination Request Fields include but not limited to: billing identification, dialed digits, electronic serial number, mobile identification number and origination triggers, mobile subscriber's billing number, if different from the mobile subscriber's directory number, called party number destination address digits, redirecting number, original called number and original destination address digits dialed, if multiple call forwarding has occurred. The presence of these parameters depends on the availability of this information from the originating network.

In step 212, the SCP 112 queries its internal tables to determine whether the number dialed in step 202 by the visiting subscriber (roamer) is long distance from the visited mobile switch 106. If the switch is capable, step 212 may be eliminated if the mobile switching center 106 has the capability. The mobile switch center 106 must have the capability to set the inter-lata toll origination triggers set when the subscriber 102 turns on the handset 104 during the registration process mentioned above enabled to use this function.

In step 214 the HLR (home location register) 122 is sent a message to determine if the subscriber 102 is still authorized to make and receive calls. The HLR 122 will respond in step 216 to the SCP whether the subscriber is authorized in a well-known manner.

The SCP 114 receives the authorization response from the HLR 122 in step 216 and responds in step 210 to the origination request record sent from the mobile switching center 106 in step 208. If the subscriber 102 is not allowed to make or receive calls the appropriate fields in the origination request will be updated. If the subscriber 102 is allowed to make and receive calls the origination request is updated and sent in step 210 specifying to allow the call to proceed in a well known manner.

If the SCP 114 determined in step 212 that the subscriber 102 dialed a long distance call in step 202 using information contained in Table 2 below or information received from the mobile switching center 106, the SCP 114 responds to the origination request message sent in step 208 with a routing number to forward the call to the IVR 118 instead of the number dialed in step 202 along with the subscriber's mobile switching center identification number, and the location identifier. The mobile identification number identifies the wireless subscriber 102. The mobile identification number is used to signal to the wireless handset 104. The mobile switching center identification number, interchangeably herein referred to as the subscriber serving mobile switching center 106, identifies the wireless subscriber's 102 serving mobile switching center. The mobile switching center identification number is used to determine the location of the call origination. The dialed digits indicate where the call set-up will be completed. The routing number may be a national number, such as the ten-digit number used to route and bill 1+ dialed calls, a toll free number, or a local number. The SCP 114 will send the original subscriber dialed number entered in step 202 to the interactive voice response unit (IVR) 118 along with the subscriber's 102 mobile identification number in step 218.

TABLE 2 Inter-Lata toll Determination fields Mobile Switching Center ID, NPA (area code), and NXX (next 3 digits after area code).

In step 210 previously mentioned, the mobile switching center 106 received a transaction capabilities application part message from the SCP 114. The Mobile Switching Center 106 will process the transaction capabilities application part message and route the call to the number returned from the (114) via the Public Switched Telephone Network 112 in step 220.

In step 220 the subscribers' 102 mobile identification number is received via the Public Switched Telephone Network when the call is routed to the Interactive voice response unit 118 in a well known manner normally referred to as Caller Id. The IVR 118 does not accept the call at this time. The IVR 118 matches the subscriber's 102 mobile identification number received in step 220 with the caller Id number received in step 218. In step 222 the IVR 118 will route the call to the original called party 124 also using the Public Switched Telephone Network 112. Step 222 can occur before step 220 is complete in order to speed the process. If the called party (124) does not answer, the call will not be accepted and the subscriber 102 will continue to hear ringing until the originating call is terminated. If the Called Party (124) answers, the IVR 118 will accept the incoming call from step 220 and connect the called party 124 using the connection established in step 222. The call will continue until the subscriber 102 or the called party 124 terminates the call.

Referring to step 220, the IVR 118 will not connect the call until the Called Party 124 answers. The IVR 118 could however play a short recorded message by accepting the call or using a well known procedure referred to as “Barge In”.

Operation of flowchart 200 is complete after step 222 is performed.

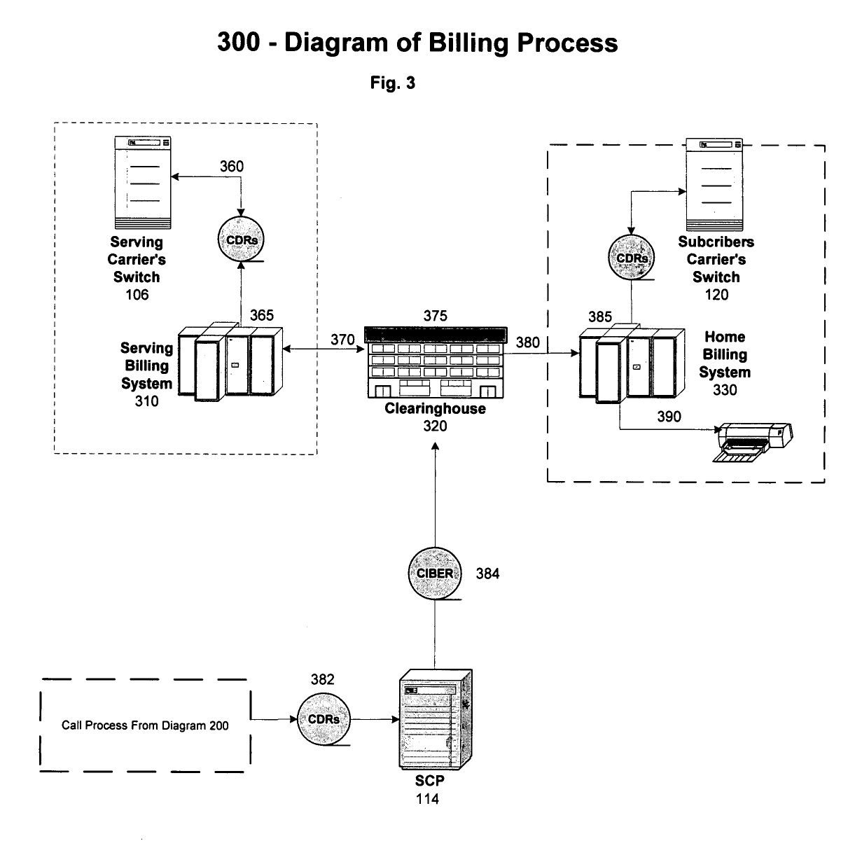

FIG. 3 represents a flow chart that illustrates the process to bill the long distance portion of the call on the subscriber's 104 monthly bill. The components shown in FIG. 1 that are involved in the process are also shown in FIG. 3 for reference. The Billing Process 300 shown in FIG. 3 occurs after step 222 is performed.

At the completion of a call described in FIG. 2 the SCP 114 will generate a record of the call detailing the information about the call including but not limited to the following fields: Date, time call duration, serving billing identification, mobile identification number and dialed digits. The record is commonly known as a Call Detail Record of CDR to those skilled in the art.

At the completion of step 222 the serving MSC 106 will also generate a CDR with the same information describe in the proceeding paragraph above, normally without charges for the long distance since the call may be routed via a “toll free” number or a local number in the process shown in FIG. 200 step 220.

In step 360 the CDR is retrieved from the mobile switching center 016 and passed to the mobile carrier's billing software 310 in a process well known to those skilled in the art.

In step 365 the serving carrier billing process will generate an industry standard CIBER (Cellular Intercarrier Billing Exchange Roamer) record and sent to one of the wireless industry clearinghouses 375 in step 370 and is identified as a “Type 10 Air Charge Record” known to those skilled in the art.

As stated above, the SCP 114 generated a Call Detail Record 382 and that information is reformatted into the Industry standard CIBER format as described as described above. The CIBER standard allows for multiple records types to be grouped together forming all the information to bill a roaming call. The CIBER record generated in step 384 will be identified as a “Type 20 or 22 Air and Toll Charge Record or “Type 30 or 32 Call Specific Charges” record in a process known to those skilled in the art.

In Step 375 the clearinghouse 320 will merge the CIBER records generated and received in steps 365, 370, 382 and 385. This process can be accomplished be keeping the 2 CIBER records separate or by merging the Type 22 record or other record types mentioned above received in step 384 with the Type 10 Air Charge Record received in step 370 and generating a new Type 10 CIBER record, dropping the 2 CIBER records received.

In step 380 the clearinghouse 320 will send the CIBER records resulting in the preceding paragraph above to the subscriber's 104 carrier's billing system 330 for processing in step 385 and added to subscriber's monthly statement in step 390.

Other embodiments of the present invention are possible. Another embodiment of the invention allows both the subscriber 102 and the receiver 124 of FIG. 1 are both wireless subscribers.

Further embodiments are possible such as embodiments that replace the wireless handset 102 and/or telephone 124 of FIG. 1 with other user interface equipment such as a computer terminal. The user interface equipment may be wireless or non-wireless.

Additional embodiments are possible that access and terminate the call using means other than a single mobile switching center 106 and a single public switched telephone network 112 shown in FIGS. 1 and 2. These embodiments may include a plurality of either mobile switching centers 106 and/or Public Switched Telephone Networks 112. Additional embodiments that are possible comprise local direct lines terminating into the Interactive Voice Response platform 118.

While the digits dialed by the subscriber 102 only are passed in an origination request message in step 208, other embodiments are possible that sends other type messages in step 210 to re-route the call to the IVR 118.

Depending on the software version in the mobile switching center, various commands may be combined to streamline the process; however the basic process will remain the same.

Additional embodiments are possible that use different standards or different variations of standards to redirect the long distance calls.

While various embodiments of the present invention have been described above, it should be understood that they have been presented by way of example only, not limitation. Thus, the breadth and scope of the present invention should not be limited by any of the above-described exemplary embodiments, but should be defined only in accordance with the following claims and their equivalents.

1. A method of choosing which long distance company a wireless roamer uses based on the selection of the wireless roamer or its home wireless carrier comprising: (1) sending a plurality of transaction capabilities application part messages between a wireless service control point and a wireless switching center, comprising the steps of: (i) sending transaction capabilities application part message that validate a roamer (ii) Instruct the service mobile switch center to pass dialed number information and; (2) routing of the call to a interactive voice response until to play a brief recorded message and; (3) routing of the wireless call to the called party

2. The method of claim 1, wherein the wireless parameters comprise: a mobile switching center identification number.

3. The method of claim 1, wherein the wireless parameters comprise: a number dialed by a caller; and a mobile switching center identification number.

4. The method of claim 1 wherein step (2) comprises: (i) receiving the number dialed by the wireless subscriber and; (ii) determine if it is a long distance call and; (iii) sending instructions to the mobile switching center to change the call routing to the interactive voice response unit via an Public Switched Telephone Network.

5. The method of claim 1 wherein step (2) comprises: (i) creating a table which will indicate by mobile switching center whether a dialed call is a long distance; (ii) activating the serving mobile switching center to send dialed digits before a wireless call is routed sending the initial address message with the mobile identification number.

6. The method of claim 1 further comprising the following steps that are performed before step (1); sending a query for one or more roaming parameters from a serving wireless mobile switching center to a home location register (HLR); and sending one or more roaming parameters from the home location register to the subscriber's home mobile switching center.

7. The method of claim 1 wherein said roaming parameters comprise: a mobile identification number.

8. The method of claim 1 wherein said roaming parameters comprise: a phone number dialed by the wireless subscriber.

9. The method of claim 1 further comprising the following steps that are performed before step (1): signaling from a telephone to a local network; signaling from the local network to a mobile switching center; sending a query for one or more roaming parameters from the mobile switching center to a home location register; and sending the roaming parameters from the home location register to the serving mobile switching center.

10. The method of claim 1 further comprising the following steps: (3) signaling from the mobile switching center to an Public Switched Telephone Network; (4) signaling from the Public Switched Telephone Network to a mobile switching center; and (5) signaling from the mobile switching center to a wireless handset.

11. The method of claim 1, wherein the mobile switching center is instructed to send only inter-lata (long distance) toll calls.

12. The method of claim 1, wherein the mobile switching center is instructed to send information to a different home location register at call startup.

13. A method for use in billing of the redirected long distance calls n the wireless subscriber's monthly statement comprising of: (1) collecting the call detail information from the serving carrier; (2) matching the call detail information with the toll charges or generation of a matching toll charge record and; (3) creating a new record to be sent to the home carrier and; (4) sending that record to a third party clearinghouse working on behalf of the wireless carrier

14. The method in accordance of claim 13 step 1 comprising of call detail information converted to an industry standard CIBER format.

15. The method in accordance of claim 13 step 2 comprising of an clearinghouse accepting industry records containing call information from multiple sources.

16. The method in accordance of claim 13 step 4 comprising of sending an industry standard format to subscriber's home carrier.
